(19) United States
(12) Patent Application Publication
(10) Pub. No.: US 2005/0180407 A1
(43) Pub. Date: Aug. 18, 2005

(54) Voice messaging service in voice over internet protocol (VoIP) system

(76) Inventor: Jung-Gi Kim, Suwon-si (KR)

Correspondence Address: Robert E. Bushnell;Suite 300, 1522 K Street, N.W., Washington, DC, 20005, US

(21) Appl. No.: 11/002,254

(22) Filed: Dec. 3, 2004

(30) Foreign Application Priority Data
Jan. 29, 2004 (KR) 2004-5860

(51) Int. Cl. H04L 12/66

(52) U.S. Cl. 370/356

(57) ABSTRACT

A voice messaging service in a VoIP system performs a messaging service for an IP terminal in the VoIP communication system including the IP terminal; an IP controller integrates a VoIP voice mail box function using VoIP technology to provide a voice messaging service to a user of the IP terminal via an IP network. The IP controller function and the voice messaging system function are contained in one piece of equipment, and thus, when a receiving terminal is on the line or does not answer, a system call process status is immediately provided via voice guidance without a separate voice reproducing apparatus, thereby providing a convenient additional service to a terminal user.

### CLAIM OF PRIORITY

This application makes reference to, incorporates the same herein, and claims all benefits accruing under 35 U.S.C. § 119 from an application for VOICE MESSAGING SERVICE APPARATUS AND METHOD THEREOF IN VoIP SYSTEM earlier filed in the Korean Intellectual Property Office on Jan. 29, 2004 and there duly assigned Serial No. 2004-5860.

### BACKGROUND OF THE INVENTION

1. Field of the Invention

The present invention relates to a voice messaging service in a Voice over Internet Protocol (VOIP) system and, more particularly, to a voice messaging service in a VoIP system which provides a voice message service and additional services to both an Internet Protocol (IP) subscriber and an office line subscriber in a VoIP network system using VoIP technology.

2. Description of the Related Art

Voice over Internet Protocol (VOIP) is a term which designates IP telephone technology for a series of facilities which transfer voice information using an IP network.

Unlike a traditional protocol based on a circuit like a Public Switched Telephone Network (PSTN), the voice information is transmitted in the form of non-sequential digital packets in VoIP technology.

The VoIP and IP telephony technology have an advantage in that a telephone service is implemented using the existing IP network as is, and so users can make a long distance call or an international telephone call via the Internet or an Intranet at a low cost.

VoIP allows a VoIP call user to find a location of other users and makes it possible to use a touch tone phone signal for automatic call distribution and voice mail, thereby encouraging ITU-T and H.323 which are international standards for transmitting IP voice data and video data on a public network such as the Internet or a private network such as an Intranet.

VoIP uses a Real Time Protocol (RTP) in addition to an original IP function in order to support packets to arrive on time. It may be difficult to secure the current Quality of Service (QoS) using a public network, but using a private network which is managed by a company or an Internet Telephony Service Provider (ITSP) can provide better service.

In general, a dedicated voice mail box system is required, the dedicated voice mail box system being equipment which stores PCM voice signals received via a PSTN interface (connected via a FXS port) and reproduces them via the PSTN interface. However, the dedicated voice mail box system cannot store/reproduce the voice in a direct connection with the IP terminal which is connected to the IP network and then process the voice data in a packetized form.

Therefore, a media gateway must be additionally installed to convert PSTN PCM voice signals into VoIP packets, and a call which needs a voice messaging service must be connected to the dedicated voice mail box system, which is connected to a PSTN, via the media gateway.

Therefore, such a voice messaging service has disadvantages in that network configuration and cost problems occur due to the addition of the media gateway.

Furthermore, a PSTN dedicated line is required for a connection between the dedicated voice mail box system and the media gateway. Therefore, there is a problem in that capacity extension depends on the number of ports of the dedicated line.

The following patents each discloses features in common with the present invention but do not teach or suggest the inventive features specifically recited in the present claims: U.S. Patent Application No. 2004/0066929 to Bremer et al., entitled SYSTEMS AND METHODS FOR INTEGRATING ANALOG VOICE SERVICE AND DERIVED POTS VOICE SERVICE IN A DIGITAL SUBSCRIBER LINE ENVIRONMENT, issued on Apr. 8, 2004; U.S. Patent Application No. 2003/0108172 to Petty et al., entitled INTERNET CALL WAITING WITH VOICEMAIL SYSTEM THAT PROVIDES MONITORING DURING RECORDING, issued on Jun. 12, 2003; U.S. Patent Application No. 2003/0012203 to Deshpande et al., entitled METHOD TO OPTIMALLY SELECT BANDWIDTH AND PRIORITY FOR VOICE MESSAGE PACKETS IN A VOICE OVER IP NETWORK, issued on Jan. 16, 2003; U.S. Patent Application No. 2004/0022373 to Suder et al., entitled VOICE MAIL IN A VOICE OVER IP TELEPHONE SYSTEM, issued on Feb. 5, 2004; and U.S. Patent Application No. 2002/0159569 to Hasegawa, entitled MESSAGING PROTOCOL OVER INTERNET PROTOCOL, issued on Oct. 31, 2002.

### SUMMARY OF THE INVENTION

It is, therefore, an object of the present invention to provide voice messaging service a VoIP system in which an IP controller integrates a VoIP voice mail box function to provide a voice messaging service to an IP terminal user via an IP network.

It is also an object of the present invention to provide voice messaging service in a VoIP system in which a low cost and simple system can be achieved by obviating a need for additional equipment such as a dedicated messaging system and a media gateway for voice signal conversion.

It is further an object of the present invention to provide a voice messaging service in a VoIP system in which capacity extension does not depend on the number of ports of a dedicated line by using an IP network instead of a separate dedicated line for a connection to a messaging system.

It is also an object of the present invention to provide a voice messaging service in a VoIP system which integrates a function of an IP controller and a function of a voice messaging system in one piece of equipment to thereby immediately provide a system call process status via voice guidance without an additional voice reproducing apparatus when a destination terminal is on the line or does not answer.

According to an embodiment of the present invention for achieving the above-noted objects, an apparatus is provided comprising: a messaging processing unit adapted to store a received voice message in a packet form in a voice mail box of a receiving terminal to which an originating terminal wants to transmit in response to the voice message being received from the originating terminal via an IP network, and the messaging processing unit further adapted to transmit the voice message in the packet form stored in the voice mail box of the receiving terminal to the receiving terminal via the IP network in response to receiving a voice message reproduction request from the receiving terminal.

The messaging processing unit is adapted to access the voice mail box of the receiving terminal to determine whether or not a stored voice message exists in response to a registration request message being received from the receiving terminal via the IP network, and wherein the messaging processing unit is further adapted to transmit a registration response message containing information as to whether or not the stored voice message exists to the receiving terminal via the IP network in response to a voice message being stored in the corresponding mail box.

The messaging processing unit is adapted transmit a voice mail box guidance request message requesting an input of the voice message to the originating terminal via the IP network in response to the receiving terminal being incapable of answering a call.

The messaging processing unit comprises: a storage portion including voice message storing areas each separated for a plurality of terminals, the storage portion adapted to store a voice message in the storing area corresponding to each terminal; a call processing portion adapted to receive, via the IP network, a voice message transmitted from a certain terminal, a reproduction request signal of the voice message stored in the storage portion, and a voice message existence confirmation request signal indicating whether or not a voice message exists in the storage portion; and a voice message processing portion adapted to store the voice message received via the call processing portion in packet form in the corresponding of the storage portion, to determine whether or not the voice message exists in the corresponding area of the storage portion in response to the confirmation request signal being received from the terminal, to transmit a voice message existence confirmation response message to the corresponding terminal via the IP network, and to transmit the voice message stored in the corresponding area for the terminal which has requested voice reproduction to the corresponding terminal via the IP network in response to a voice message reproduction request signal being received via the call processing portion.

The voice message existence confirmation request signal transmitted from the terminal is included in a registration request message periodically transmitted via the IP network.

The voice message processing portion comprises: a voice mail box processing portion adapted to transmit a voice guidance message for a voice input request stored in the storage portion to the originating terminal via the IP network in response to the receiving terminal being incapable of answering a call, to access a corresponding voice message file from the storage portion and to request reproduction of the corresponding voice message file in response to a reproduction request signal of the voice message stored in the storage portion being received from the originating terminal, and to access the storage portion to transmit information as to whether or not the voice message exists to the corresponding IP terminal via the IP network in response to the voice message existence confirmation request signal being received from the originating terminal; and a packet processing portion adapted to store a received voice message in the corresponding area of the storage portion in response to the voice message being received via the voice mail box processing portion, and to transmit a voice message from the storage portion in RTP packet form to the corresponding IP terminal that requested the voice message via the IP network in response to a request from the voice mail box processing portion.

The voice guidance message for the voice input request includes a message indicating a current status of a destination terminal.

The voice message file reproduction request signal transmitted from the voice mail box processing portion to the packet processing portion includes at least one of IP address information of the IP terminal that requested the voice message, and voice message storing file name information.

The apparatus further comprises: an IP network interface portion connected to the IP terminal via the IP network and adapted to interface a call signal and a voice message with the IP terminal; and a PSTN interface portion connected to an office line terminal via a PSTN and adapted to interface transmission and reception of a call signal and transmission and reception of a voice message with the office line terminal via the PSTN.

According to another embodiment of the present invention for achieving the above-noted objects, an apparatus is provided comprising: a voice message storage processing portion adapted to transmit a voice message input request message to an originating terminal via an IP network in response to a receiving terminal being incapable of answering a call request signal originated from the origination terminal, and to store a received voice message in packet form in a voice mail box of the receiving terminal in response to the voice message being received from the originating terminal; a voice message confirm processing portion adapted to access the voice mail box of the receiving terminal and to transmit information as to whether or not a voice message exists to the receiving terminal via the IP network in response to a signal asking whether or not a stored voice message exists being received from the receiving terminal; and a voice message transmission processing portion adapted to transmit the voice message in packet form stored in the voice mail box of the receiving terminal to the receiving terminal via the IP network in response to a voice message reproduction request from the receiving terminal.

According to another embodiment of the present invention for achieving the above-noted objects, a method is provided comprising: storing a received voice message in packet form in a voice mail box of a receiving terminal to which an originating terminal wants to transmit in response to a request of a voice mail box processing portion upon the voice message being received from the originating terminal via an IP network; and transmitting the voice message in packet form stored in the voice mail box of the receiving terminal to the receiving terminal via the IP network in response a voice message reproduction request signal being received from the receiving terminal.

The voice message reproduction request signal includes at least one of voice mail box number information, IP address information, and voice message storing file information of the receiving terminal.

Storing the received voice message comprises: determining whether or not the receiving terminal is capable of answering a call in response to a call request signal being received from the originating terminal to the receiving terminal via the IP network; transmitting a voice message input request message containing a voice message representing a current status of the receiving terminal to the originating terminal via the IP network in response to a determination that the receiving terminal is incapable of answering a call; and storing the received voice message in RTP packet form in the voice mail box of the receiving terminal in response to the voice message being received from the originating terminal.

Transmitting the voice message to the receiving terminal via the IP network comprises: reading a corresponding voice message from the voice mail box using the received voice mail box information of the receiving terminal in response to a stored voice message reproduction request signal containing the voice mail box information being received from the receiving terminal via the IP network; and transmitting the read voice message in RTP packet form to the receiving terminal via the IP network.

The voice mail box information includes IP address information and voice message storing file name information.

The method further comprises: accessing the voice mail box of the receiving terminal to determine whether or not a stored voice mail exists in response to a voice message existence confirmation request message being received from the receiving terminal via the IP network; and transmitting a registration response message containing information as to whether or not the voice message exists to the receiving terminal via the IP network in response to a determination that a stored voice message exists in the corresponding voice mail box.

The voice message existence confirmation request signal transmitted from the receiving terminal is included in the registration request message periodically transmitted via the IP network.

According to yet another embodiment of the present invention for achieving the above-noted objects, a method is provided comprising: storing a received voice message in packet form in a voice mail box of a receiving terminal in response to the voice message being received from an originating terminal upon the receiving terminal being unable to answer a call request signal from the originating terminal via an IP network; and accessing the voice mail box of the receiving terminal to determine whether or not a stored voice message exists in response to a voice message existence confirmation request message being received from the receiving terminal via the IP network, and then transmitting a registration response message to the receiving terminal via the IP network upon a determination that a voice message is stored in the corresponding voice mail box, the registration response message including information as to whether or not the voice message exists; and transmitting the voice message in packet form stored in the voice mail box of the receiving terminal to the receiving terminal via the IP network in response to a voice message reproduction request signal being received from the receiving terminal.

The voice message existence confirmation request signal transmitted from the receiving terminal is included in a registration request message periodically transmitted via the IP network.

The voice message reproduction request signal includes at least one of vice mail box number information, IP address information, and voice message storing file information of the receiving terminal.

Storing the received voice message comprises: determining whether or not the receiving terminal is capable of answering a call in response to a call request signal being received from the originating terminal to the receiving terminal via the IP network; transmitting a voice message input request message to the originating terminal via the IP network in response to a determination that the receiving terminal is incapable of answering a call; and storing the received voice message in RTP packet form in a voice mail box of the receiving terminal in response to the voice message being received from the originating terminal.

Transmitting the voice message to the receiving terminal via the IP network comprises: reading a corresponding voice message from the voice mail box using the received voice mail box information of the receiving terminal in response to a voice message reproduction request signal containing the voice mail box information being received from the receiving terminal via the IP network; and transmitting the read voice message in RTP packet form to the receiving terminal via the IP network.

The voice mail box information includes IP address information and voice message storing file name information.

According to yet another embodiment of the present invention for achieving the above-noted objects, a program storage device, readable by a machine, tangibly embodying a program of instructions executable by the machine to perform a method is provided, the method comprising: storing a received voice message in packet form in a voice mail box of a receiving terminal to which an originating terminal wants to transmit in response to a request of a voice mail box processing portion upon the voice message being received from the originating terminal via an IP network; and transmitting the voice message in packet form stored in the voice mail box of the receiving terminal to the receiving terminal via the IP network in response a voice message reproduction request signal being received from the receiving terminal.

The voice message reproduction request signal includes at least one of voice mail box number information, IP address information, and voice message storing file information of the receiving terminal.

Storing the received voice message comprises: determining whether or not the receiving terminal is capable of answering a call in response to a call request signal being received from the originating terminal to the receiving terminal via the IP network; transmitting a voice message input request message containing a voice message representing a current status of the receiving terminal to the originating terminal via the IP network in response to a determination that the receiving terminal is incapable of answering a call; and storing the received voice message in RTP packet form in the voice mail box of the receiving terminal in response to the voice message being received from the originating terminal.

Transmitting the voice message to the receiving terminal via the IP network comprises: reading a corresponding voice message from the voice mail box using the received voice mail box information of the receiving terminal in response to a stored voice message reproduction request signal containing the voice mail box information being received from the receiving terminal via the IP network; and transmitting the read voice message in RTP packet form to the receiving terminal via the IP network.

The voice mail box information includes IP address information and voice message storing file name information.

The method further comprising: accessing the voice mail box of the receiving terminal to determine whether or not a stored voice mail exists in response to a voice message existence confirmation request message being received from the receiving terminal via the IP network; and transmitting a registration response message containing information as to whether or not the voice message exists to the receiving terminal via the IP network in response to a determination that a stored voice message exists in the corresponding voice mail box,.

The voice message existence confirmation request signal transmitted from the receiving terminal is included in the registration request message periodically transmitted via the IP network.

According to still another embodiment of the present invention for achieving the above-noted objects, a program storage device, readable by a machine, tangibly embodying a program of instructions executable by the machine to perform a method is provided, the method comprising: storing a received voice message in packet form in a voice mail box of a receiving terminal in response to the voice message being received from an originating terminal upon the receiving terminal being unable to answer a call request signal from the originating terminal via an IP network; and accessing the voice mail box of the receiving terminal to determine whether or not a stored voice message exists in response to a voice message existence confirmation request message being received from the receiving terminal via the IP network, and then transmitting a registration response message to the receiving terminal via the IP network upon a determination that a voice message is stored in the corresponding voice mail box, the registration response message including information as to whether or not the voice message exists; and transmitting the voice message in packet form stored in the voice mail box of the receiving terminal to the receiving terminal via the IP network in response to a voice message reproduction request signal being received from the receiving terminal.

The voice message existence confirmation request signal transmitted from the receiving terminal is included in a registration request message periodically transmitted via the IP network.

The voice message reproduction request signal includes at least one of vice mail box number information, IP address information, and voice message storing file information of the receiving terminal.

Storing the received voice message comprises: determining whether or not the receiving terminal is capable of answering a call in response to a call request signal being received from the originating terminal to the receiving terminal via the IP network; transmitting a voice message input request message to the originating terminal via the IP network in response to a determination that the receiving terminal is incapable of answering a call; and storing the received voice message in RTP packet form in a voice mail box of the receiving terminal in response to the voice message being received from the originating terminal.

Transmitting the voice message to the receiving terminal via the IP network comprises: reading a corresponding voice message from the voice mail box using the received voice mail box information of the receiving terminal in response to a voice message reproduction request signal containing the voice mail box information being received from the receiving terminal via the IP network; and transmitting the read voice message in RTP packet form to the receiving terminal via the IP network.

The voice mail box information includes IP address information and voice message storing file name information.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a view of a networking configuration for a voice messaging service system in a VoIP network.

FIG. 2 is a view of a networking configuration for a voice messaging service system in a VoIP network according to an embodiment of the present invention;

FIG. 3 is a detailed block diagram of the VoIP voice mail box system shown in FIG. 2;

FIG. 4 is a view of a voice message storing method for a voice messaging service in a VoIP system according to an embodiment of the present invention;

FIG. 5 is a view of a method for periodically informing a user of whether a stored voice message exists in a voice mail box for a voice messaging service in a VoIP system according to an embodiment of the present invention; and

FIG. 6 is a view of a method of reproducing a voice message stored in a voice mail box for a voice messaging service in a VoIP system according to an embodiment of the present invention.

### DETAILED DESCRIPTION OF THE INVENTION

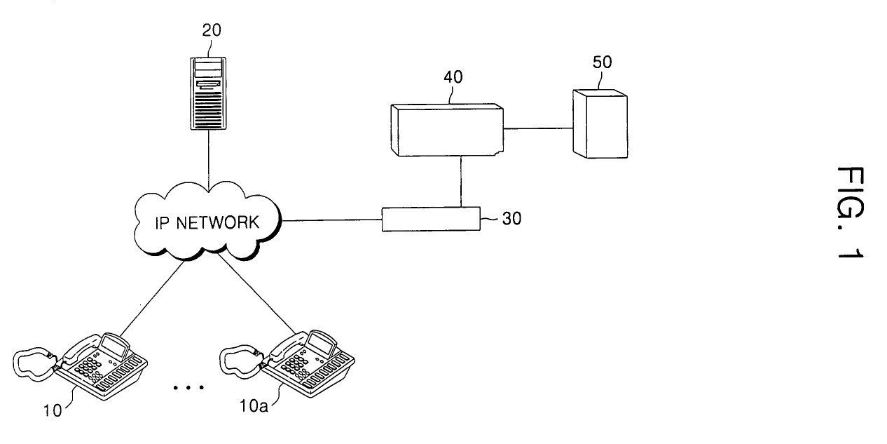

FIG. 1 is a view of a networking configuration for a voice messaging service system in a VoIP network.

As shown in FIG. 1, IP terminals 10 and 10a with a VoIP function, an IP controller 20 which is connected to the IP terminals 10 and 10a via an IP network and performs a call processing service for the IP terminals 10 and 10a, a dedicated voice mail box system 50 which is connected to a Public Service Telephone Network (PSTN) and performs a voice messaging service, and a media gateway 30 which is connected to the IP controller 20 via the IP network and to the voice mail box dedicated system 50 via a PSTN dedicated line, converts IP packets for a voice signal received from the IP network into Pulse Code Modulation (PCM) signals which are stored in the voice mail box dedicated system 50 via an exchanger 40, and converts the PCM signals received from the exchanger 40 into IP packets which are provided to the IP controller 20 via the IP network. The IP terminals 10 and 10a can include a Session Initiation Protocol (SIP) terminal or an H.323 terminal, and the IP controller 20 generally includes an SIP server or a gatekeeper.

When an incoming call is received from the IP terminals 10 and 10a via the IP network, the IP controller 20 connects the received incoming call to a destination terminal. If the destination terminal is on the line or does not answer, a user can leave a voice message for the destination terminal. At this time, the IP controller 20 connects the user to the dedicated voice mail box system 50, which is connected via the PSTN dedicated line and the media gateway 30, so that the user can leave a voice message in a corresponding voice mail box of the dedicated voice mail box system 50.

In general, the dedicated voice mail box system 50 is equipment which stores PCM voice signals received via a PSTN interface (connected via a FXS port) and reproduces them via the PSTN interface. However, the dedicated voice mail box system 50 cannot store/reproduce the voice in a direct connection with the IP terminal which is connected to the IP network and then process the voice data in a packetized form.

Therefore, the media gateway 30 must be additionally installed to convert PSTN PCM voice signals into VoIP packets, and a call which needs a voice messaging service must be connected to the dedicated voice mail box system 50, which is connected to a PSTN, via the media gateway 30.

Therefore, such a voice messaging service has disadvantages in that network configuration and cost problems occur due to the addition of the media gateway 30.

Furthermore, a PSTN dedicated line is required for a connection between the dedicated voice mail box system 50 and the media gateway 30. Therefore, there is a problem in that capacity extension depends on the number of ports of the dedicated line.

Hereinafter, a voice messaging service in a VoIP system according to an embodiment of the present invention is explained below in detail with reference to the attached drawings.

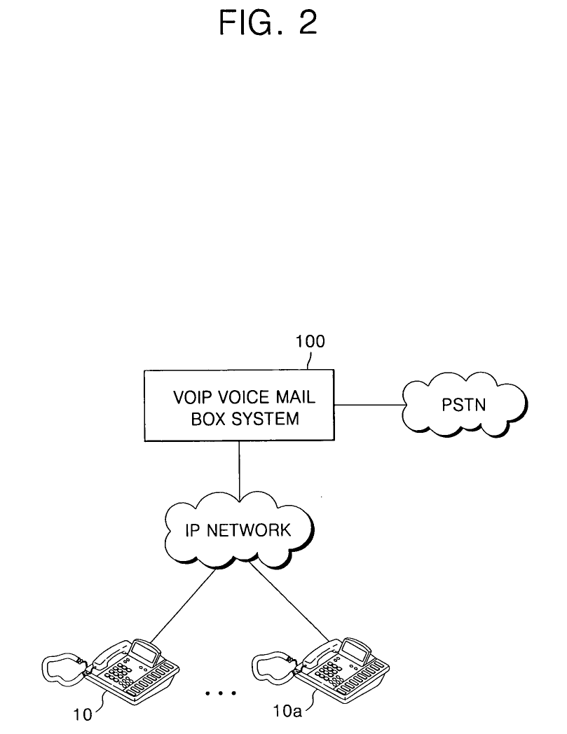

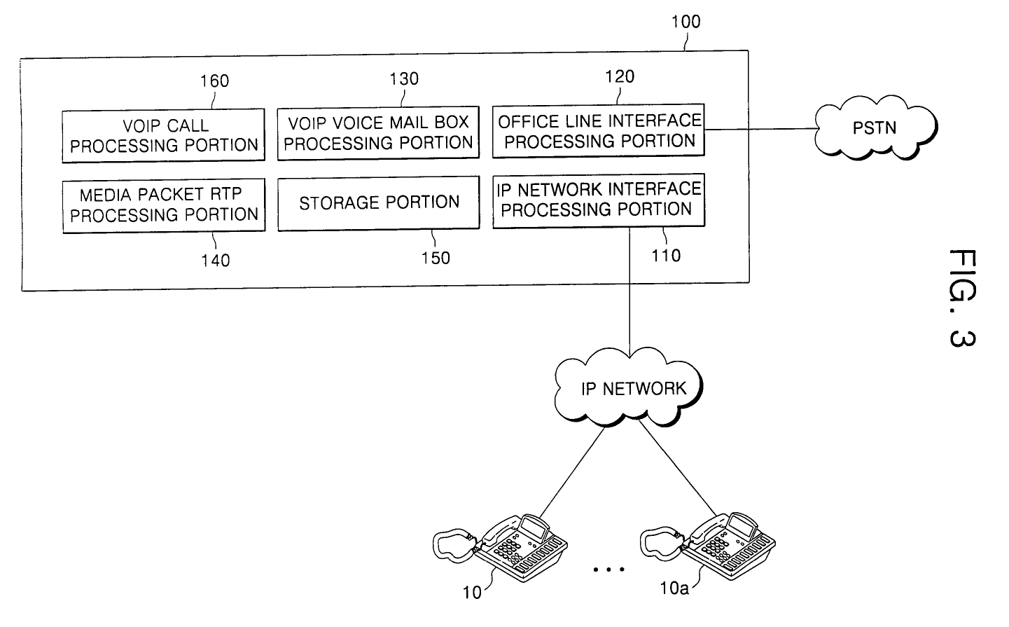

FIG. 2 is a view of a networking configuration for a voice messaging service system in a VoIP network according to an embodiment of the present invention, and FIG. 3 is a detailed block diagram of the VoIP voice mail box system shown in FIG. 2.

As shown in FIG. 2, the voice messaging service apparatus in the VoIP system according to an embodiment of the present invention comprises a VoIP voice mail box system 100 which is connected to IP terminals 10 and 10a via an IP network and integrates a voice mail box system to provide call connection control between the IP terminals 10 and 10a and a voice messaging service. That is, the VoIP voice mail box system 100 is a VoIP integration module which integrates an IP controller for providing an H.323 gatekeeper function and an SIP server function, and a VoIP voice messaging system for storing VoIP voice packets and reproducing the voice packets stored according to a request of a user. The VoIP integration module may further include a PSTN office line module for providing a PSTN office line interface.

The VoIP voice mail box system 100, as shown in FIG. 3, may include an IP network interface processing portion 110, an office line interface processing portion 120, a VoIP voice mail box processing portion 130, a media packet RTP processing portion 140, a storage portion 150, and a VoIP call processing portion 160.

The VoIP call processing portion 160 is a module which performs the same function as the IP controller 20 of FIG. 1, and performs a signal processing function of a VoIP signaling standard protocol such as H.323 or SIP which controls incoming call processing or originating call processing of the IP terminals 10 and 10a.

That is, the VoIP call processing portion 160 performs a routing process for registration of the IP terminals 10 and 10a and an originating/incoming call request of the IP terminals 10 and 10a, and functions to process a status (busy, a call termination, a call forwarding) of the IP terminals 10 and 10a which are on the line.

In response to a messaging process request of the respective IP terminals 10 and 10a, the VoIP voice mail box processing portion 130 manages a database related to storing and reproducing a VoIP voice packet, i.e., the storage portion 150, and performs a voice mail box control function for providing voice guidance required for a messaging process to the IP terminals 10 and 10a. That is, the VoIP voice mail box processing portion 130 performs a voice mail box control processing function, an automatic console control processing function, and a voice memo control processing function.

The office line interface processing portion 120 is connected to a PSTN exchanger (not shown) via a PSTN line to perform a function of processing an originating/incoming call interface for the PSTN office line of the IP terminals 10 and 10a.

The media packet RTP processing portion 140 converts voice signals produced from the office line interface processing portion 120 and the IP terminals 10 and 10a into VoIp voice packets using VoIP technology and stores them in the storage portion 150, and transmits the stored voice packets via the IP network interface processing portion 110 to the IP terminals 10 and 10a so that the IP terminals 10 and 10a can reproduce them. Such a function can be performed by separate VoIP hardware or software using a VoIP software codec technology.

The storage portion 150 is used as an auxiliary memory for storing a VoIP packet (RTP packet) in the media packet RTP processing portion 140, and stores and reproduces the RTP packet form as is without any conversion.

The IP network interface processing portion 110 performs a function of accessing the IP network via an Ethernet technology and a TCP/IP protocol.

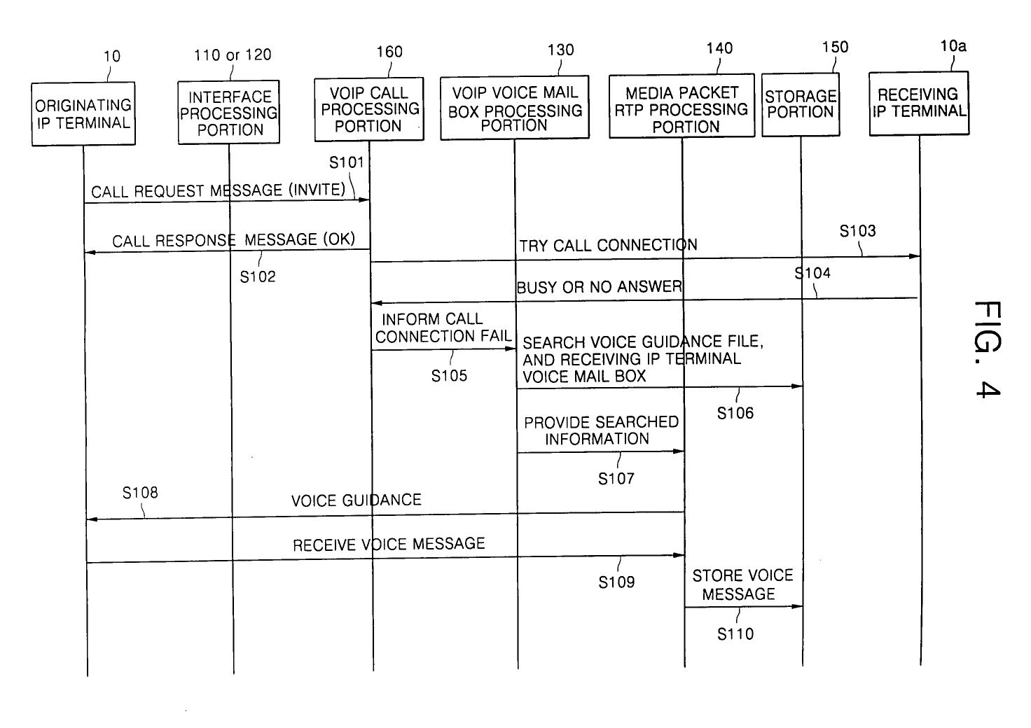

A VoIP voice messaging service of the voice messaging service apparatus in the VoIP system according to an embodiment of the present invention is explained below with reference to FIGS. 4 to 6.

FIG. 4 is a view of a voice message storing method for a voice messaging service in a VoIP system according to an embodiment of the present invention.

As shown in FIG. 4, when a call request signal (INVITE message) is received via the IP network interface processing portion 110 from the originating IP terminal 10 (S101), the VoIP call processing portion 160 transmits a response message (OK message) via the IP network interface processing portion 120 in response to the call request of the originating IP terminal 10 (S102), and then tries to establish a call connection to a destination (receiving) IP terminal 10a via the IP network (S103).

When the receiving IP terminal 10a is on the line or does not answer while trying the call connection (S104), the VoIP call processing portion 160 transmits a call connection fail message to the VoIP voice mail box processing portion 130 (S105).

The VoIP voice mail box processing portion 130 searches a voice guidance file for the voice mail box processing from the storage portion 150 according to the call connection fail message transmitted from the VoIP call processing portion 160, accesses information about the destination IP terminal 10a (S106), and transmits the accessed information to the media packet RTP processing portion 140 (S107). The information about the destination IP terminal 10a includes at least one of telephone number information, IP address information, and a message storing file name information.

The media packet RTP processing portion 140 reproduces the voice guidance file provided from the VoIP voice mail box processing portion 130 and transmits it to the originating IP terminal 10 via the IP network (S108).

Thereafter, when a voice message inputted from a user is received from the originating IP terminal 10 via the IP network (S109), the VoIP voice mail box processing portion 130 stores the received voice message in the form of an RTP packet in a voice mail box of the receiving IP terminal 10a (S110).

The voice message storing method described above can be summarized as follows. An incoming call request to a specific IP terminal from an office line IP terminal or an extension IP terminal is forwarded to the VoIP call processing portion 160 via the office line interface processing portion 120 or the IP interface processing portion 110, and when the corresponding destination IP terminal is in a situation (no answer or busy) incapable of receiving a call, the VoIP call processing portion 160 inform the situation to the VoIP voice mail box processing portion 130, and the VoIP voice mail box processing portion 130 accesses a voice guidance file for the voice mail box processing from the storage portion 150 and provides the media packet RTP processing portion 140 with the voice guidance file and information of the corresponding destination IP terminal (e.g., telephone number, IP address, and message storing file name). The media packet RTP processing portion 140 reproduces the voice guidance file for a voice mail box service and also stores voice messages received from the originating IP terminal (office line terminal or IP terminal) via the interface processing portions 110 and 120 in a designated file in an RTP packet form.

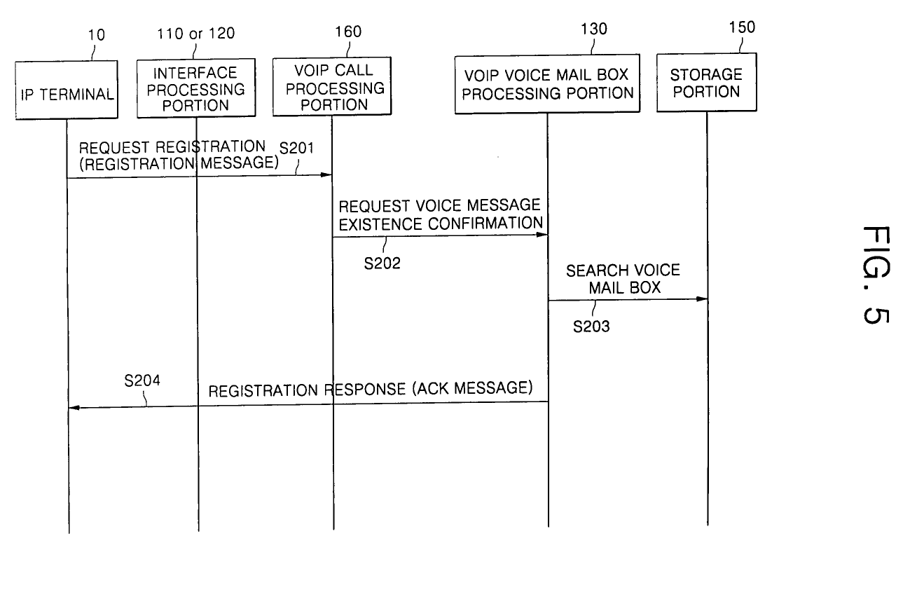

As described above, when a voice message is stored, a method of periodically informing the IP terminal 10a that the stored voice message exists is explained below with reference to FIG. 5.

FIG. 5 is a view of a method of periodically informing an IP terminal that stored voice message exists in a voice mail box for a voice messaging service in a VoIP system according to an embodiment of the present invention.

As shown in FIG. 5, the IP terminal 10 periodically communicates with the VoIP call processing portion 160 via the IP network interface processing portion 110 for its current location registration process.

When a registration request signal (REGISTER message) is received within a preset period from the IP terminal 10 (S201), the VoIP call processing portion 160 transmits an existence confirmation request message of a stored voice message to the VoIP voice mail box processing portion 130 (S202).

The VoIP voice mail box processing portion 130 checks whether or not the stored voice message exists in a voice mail box of a corresponding office line terminal or IP terminal in the storage portion 150 in response to the existence confirmation request message transmitted from the VoIP call processing portion 160 (S203).

As a result of the search, if a stored voice message exists in a voice mail box of the corresponding terminal, the VoIP voice mail box processing portion 130 transmits a registration response (ACK) message for informing the corresponding terminal that a voice message is stored in a voice mail box, via the interface processing portions 110 and 120, whereby a user can easily confirm whether or not a voice message exists (S204).

That is, the method of informing whether or not a stored voice message exists is as follows. The IP terminal communicates with the VoIP call processing portion 160 via a periodical location registration process, and when there is a registration request from the IP terminal, the VoIP call processing portion 160 asks the VoIP voice mail box processing portion 130 whether or not the voice message exists, and when there is a stored voice message, a registration response message with the voice message storing information is transmitted, whereby the corresponding IP terminal is informed of existence of a voice message.

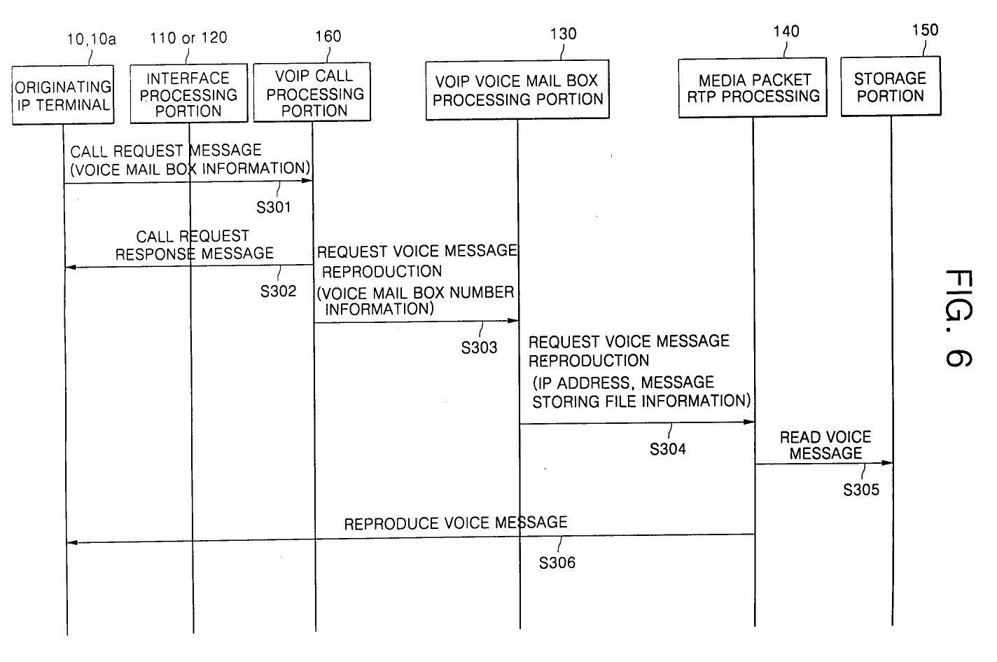

When a stored voice message exists in its voice mail box, a method of transmitting the stored voice message to the IP terminal is explained below with reference to FIG. 6.

FIG. 6 is a view of a method of reproducing a voice message stored in a voice mail box for a vice messaging service in a VoIP system according to an embodiment of the present invention.

As shown in FIG. 6, when a call request signal is received from the office line terminal or the originating IP terminals 10 and 10a via the interface processing portions 110 and 120 (S301), the VoIP call processing portion 160 transmits a response message to the corresponding IP terminal via the interface processing portions 110 and 120 (S302). The call request signal transmitted from the IP terminal can include its voice mail box number information.

The VoIP call processing portion 160 transmits a voice message reproduction request signal containing voice mail box number information of the originating IP terminal contained in the call request signal to the VoIP voice mail box processing portion 130 in response to the call request signal transmitted from the originating IP terminals 10 and 10a (S303).

The VoIP voice mail box processing portion 130 provides the media packet RTP processing portion 140 with the voice message reproduction request signal in response to the voice message reproduction request signal transmitted from the VoIP call processing portion 160 (S304). When the VoIP voice mail box processing portion 130 transmits the voice message reproduction request signal to the media packet RTP processing portion 140, information for the corresponding terminal such as IP address information and message storing file information is transmitted together with the voice message reproduction request signal.

The media packet RIP processing portion 140 reads the voice message stored in the voice mail box from the storage portion 150 using the information for the corresponding terminal provided by the VoIP voice mail box processing portion 130 (S305) and transmits it to the corresponding IP terminals 10 and 10a in an RTP form, thereby reproducing the voice message (S306).

That is, a method of reproducing the voice message stored in the voice mail box is summarized as follows. When the IP terminal wants to hear the stored voice message, the call request signal containing the voice mail box number of the corresponding terminal is transmitted to the VoIP call processing portion 160, and then the VoIP call processing portion 160 requests a process for reproducing the stored voice message for the corresponding IP terminal to the VoIP voice mail box processing portion 130.

The VoIP voice mail box processing portion 130 finds the voice message file to be reproduced for the corresponding IP terminal, transmits the corresponding IP terminal information (e.g., IP address and voice message storing file name) and requests the media packet RTP processing portion 140 to reproduce the voice message.

The media packet RTP processing portion 140 reads the message storing file using the requested information and transmits it to the corresponding IP terminal in the RTP form, whereby the stored voice message is reproduced.

On the other hand, according to the prior art, when a receiving terminal is on the line or does not answer, an originating terminal is informed of the receiving terminal's status via a PCM tone signal such as a busy tone or an error tone. However, as an additional service of a voice message service according to the present invention, when an IP terminal originates a call, the VoIP call processing portion 160 checks a system status and finds a voice guidance file previously stored corresponding to the system status, and requests the media packet RTP processing portion 140 to reproduce it, so that the IP terminal is provided with the system status via a voice message, and thus call process information for the system status can be immediately provided in a voice form to the originating terminal.

As described above, the voice messaging service apparatus and method thereof in the VoIP system according to the present invention perform a messaging service for an IP terminal in the VoIP communication system including the IP terminal such that the IP controller integrates the VoIP voice mail box function using the VoIP technology to provide a voice messaging service to a user of the IP terminal via the IP network.

Also, a separate dedicated message system for a voice messaging service and a media gateway for voice conversion are not additionally provided, so that the system configuration is simplified and its cost is significantly reduced.

Furthermore, a separate dedicated line for a connection with a messaging system is not used, and the IP network is used instead, and thus capacity extension is not limited to the number of ports of the dedicated line for a connection to the messaging system.

Furthermore, the function of the IP controller and the function of the voice messaging system are contained in one piece of equipment, and thus, when a receiving terminal is on the line or does not answer, a system call process status is immediately provided via voice guidance without a separate voice reproducing apparatus, thereby providing a convenient additional service to a terminal user.

1. An apparatus comprising:
a messaging processing unit adapted to store a received voice message in a packet form in a voice mail box of a receiving terminal to which an originating terminal wants to transmit in response to the voice message being received from the originating terminal via an IP network, and
the messaging processing unit further adapted to transmit the voice message in the packet form stored in the voice mail box of the receiving terminal to the receiving terminal via the IP network in response to receiving a voice message reproduction request from the receiving terminal.

2. The apparatus according to claim 1, wherein the messaging processing unit is adapted to access the voice mail box of the receiving terminal to determine whether or not a stored voice message exists in response to a registration request message being received from the receiving terminal via the IP network, and
wherein the messaging processing unit is further adapted to transmit a registration response message containing information as to whether or not the stored voice message exists to the receiving terminal via the IP network in response to a voice message being stored in the corresponding mail box.

3. The apparatus according to claim 1, wherein the messaging processing unit is adapted transmit a voice mail box guidance request message requesting an input of the voice message to the originating terminal via the IP network in response to the receiving terminal being incapable of answering a call.

4. The apparatus according to claim 1, wherein the messaging processing unit comprises:
a storage portion including voice message storing areas each separated for a plurality of terminals, the storage portion adapted to store a voice message in the storing area corresponding to each terminal;
a call processing portion adapted to receive, via the IP network, a voice message transmitted from a certain terminal, a reproduction request signal of the voice message stored in the storage portion, and a voice message existence confirmation request signal indicating whether or not a voice message exists in the storage portion; and
a voice message processing portion adapted to store the voice message received via the call processing portion in packet form in the corresponding of the storage portion, to determine whether or not the voice message exists in the corresponding area of the storage portion in response to the confirmation request signal being received from the terminal, to transmit a voice message existence confirmation response message to the corresponding terminal via the IP network, and to transmit the voice message stored in the corresponding area for the terminal which has requested voice reproduction to the corresponding terminal via the IP network in response to a voice message reproduction request signal being received via the call processing portion.

5. The apparatus according to claim 4, wherein the voice message existence confirmation request signal transmitted from the terminal is included in a registration request message periodically transmitted via the IP network.

6. The apparatus according to claim 4, wherein the voice message processing portion comprises:
a voice mail box processing portion adapted to transmit a voice guidance message for a voice input request stored in the storage portion to the originating terminal via the IP network in response to the receiving terminal being incapable of answering a call, to access a corresponding voice message file from the storage portion and to request reproduction of the corresponding voice message file in response to a reproduction request signal of the voice message stored in the storage portion being received from the originating terminal, and to access the storage portion to transmit information as to whether or not the voice message exists to the corresponding IP terminal via the IP network in response to the voice message existence confirmation request signal being received from the originating terminal; and
a packet processing portion adapted to store a received voice message in the corresponding area of the storage portion in response to the voice message being received via the voice mail box processing portion, and to transmit a voice message from the storage portion in RTP packet form to the corresponding IP terminal that requested the voice message via the IP network in response to a request from the voice mail box processing portion.

7. The apparatus according to claim 6, wherein the voice guidance message for the voice input request includes a message indicating a current status of a destination terminal.

8. The apparatus according to claim 6, wherein the voice message file reproduction request signal transmitted from the voice mail box processing portion to the packet processing portion includes at least one of IP address information of the IP terminal that requested the voice message, and voice message storing file name information.

9. The apparatus according to claim 1, further comprising:
an IP network interface portion connected to the IP terminal via the IP network and adapted to interface a call signal and a voice message with the IP terminal; and
a PSTN interface portion connected to an office line terminal via a PSTN and adapted to interface transmission and reception of a call signal and transmission and reception of a voice message with the office line terminal via the PSTN.

10. An apparatus comprising:
a voice message storage processing portion adapted to transmit a voice message input request message to an originating terminal via an IP network in response to a receiving terminal being incapable of answering a call request signal originated from the origination terminal, and to store a received voice message in packet form in a voice mail box of the receiving terminal in response to the voice message being received from the originating terminal;
a voice message confirm processing portion adapted to access the voice mail box of the receiving terminal and to transmit information as to whether or not a voice message exists to the receiving terminal via the IP network in response to a signal asking whether or not a stored voice message exists being received from the receiving terminal; and
a voice message transmission processing portion adapted to transmit the voice message in packet form stored in the voice mail box of the receiving terminal to the receiving terminal via the IP network in response to a voice message reproduction request from the receiving terminal.

11. A method comprising:
storing a received voice message in packet form in a voice mail box of a receiving terminal to which an originating terminal wants to transmit in response to a request of a voice mail box processing portion upon the voice message being received from the originating terminal via an IP network; and
transmitting the voice message in packet form stored in the voice mail box of the receiving terminal to the receiving terminal via the IP network in response a voice message reproduction request signal being received from the receiving terminal.

12. The method according to claim 11, wherein the voice message reproduction request signal includes at least one of voice mail box number information, IP address information, and voice message storing file information of the receiving terminal.

13. The method according to claim 11, wherein storing the received voice message comprises:
determining whether or not the receiving terminal is capable of answering a call in response to a call request signal being received from the originating terminal to the receiving terminal via the IP network;
transmitting a voice message input request message containing a voice message representing a current status of the receiving terminal to the originating terminal via the IP network in response to a determination that the receiving terminal is incapable of answering a call; and
storing the received voice message in RTP packet form in the voice mail box of the receiving terminal in response to the voice message being received from the originating terminal.

14. The method according to claim 12, wherein transmitting the voice message to the receiving terminal via the IP network comprises:
reading a corresponding voice message from the voice mail box using the received voice mail box information of the receiving terminal in response to a stored voice message reproduction request signal containing the voice mail box information being received from the receiving terminal via the IP network; and
transmitting the read voice message in RTP packet form to the receiving terminal via the IP network.

15. The method according to claim 11, further comprising:
accessing the voice mail box of the receiving terminal to determine whether or not a stored voice mail exists in response to a voice message existence confirmation request message being received from the receiving terminal via the IP network; and
transmitting a registration response message containing information as to whether or not the voice message exists to the receiving terminal via the IP network in response to a determination that a stored voice message exists in the corresponding voice mail box,.

16. A method comprising:
storing a received voice message in packet form in a voice mail box of a receiving terminal in response to the voice message being received from an originating terminal upon the receiving terminal being unable to answer a call request signal from the originating terminal via an IP network; and
accessing the voice mail box of the receiving terminal to determine whether or not a stored voice message exists in response to a voice message existence confirmation request message being received from the receiving terminal via the IP network, and then transmitting a registration response message to the receiving terminal via the IP network upon a determination that a voice message is stored in the corresponding voice mail box, the registration response message including information as to whether or not the voice message exists; and
transmitting the voice message in packet form stored in the voice mail box of the receiving terminal to the receiving terminal via the IP network in response to a voice message reproduction request signal being received from the receiving terminal.

17. The method according to claim 16, wherein storing the received voice message comprises:
determining whether or not the receiving terminal is capable of answering a call in response to a call request signal being received from the originating terminal to the receiving terminal via the IP network;
transmitting a voice message input request message to the originating terminal via the IP network in response to a determination that the receiving terminal is incapable of answering a call; and
storing the received voice message in RTP packet form in a voice mail box of the receiving terminal in response to the voice message being received from the originating terminal.

18. The method according to claim 16, wherein transmitting the voice message to the receiving terminal via the IP network comprises:
reading a corresponding voice message from the voice mail box using the received voice mail box information of the receiving terminal in response to a voice message reproduction request signal containing the voice mail box information being received from the receiving terminal via the IP network; and
transmitting the read voice message in RTP packet form to the receiving terminal via the IP network.

19. The method according to claim 18, wherein the voice mail box information includes IP address information and voice message storing file name information.

20. A program storage device, readable by a machine, tangibly embodying a program of instructions executable by the machine to perform a method comprising:
storing a received voice message in packet form in a voice mail box of a receiving terminal to which an originating terminal wants to transmit in response to a request of a voice mail box processing portion upon the voice message being received from the originating terminal via an IP network; and
transmitting the voice message in packet form stored in the voice mail box of the receiving terminal to the receiving terminal via the IP network in response a voice message reproduction request signal being received from the receiving terminal.
